(19) United States
(12) Patent Application Publication
(10) Pub. No.: US 2025/0263959 A1
(43) Pub. Date: Aug. 21, 2025

(54) TAILGATE HINGE ASSEMBLY

(71) Applicant: FCA US LLC, Auburn Hills, MI (US)

(72) Inventors: Manmohan Srikrishna, Rochester, MI (US); Michael Vizcarra Gomez, Mexico City (MX); Carlos Alberto Dominguez Gabino, Mexico City (MX); Eric Ghoukasian Khouygani, Troy, MI (US)

(21) Appl. No.: 18/442,345

(22) Filed: Feb. 15, 2024

(51) Int. Cl. E05D 3/02; B62D 33/027

(52) U.S. Cl. CPC E05D 3/02; B62D 33/0273; E05Y 2600/61; E05Y 2900/544

(57) ABSTRACT

A hinge assembly configured to couple either a motorized tailgate or a non-motorized tailgate to a side wall of a bed of a vehicle. The hinge assembly includes a hinge bracket configured to be fixed to the side wall, and an elongated hinge key having a proximate end attached to the hinge bracket and a distal end including a keyed surface, wherein the elongated hinge key is configured to be fixed to a first cup that is configured to be attached to the motorized tailgate and configured to be received within a second cup that is configured to be attached to the non-motorized tailgate such that the second cup can rotate about the elongated hinge key.

### FIELD

The present disclosure relates to a tailgate hinge assembly.

### BACKGROUND

This section provides background information related to the present disclosure which is not necessarily prior art.

Tailgates are pivotal components of various vehicles, especially trucks and utility vehicles, providing access to a cargo area. Tailgate hinge assemblies have been designed with a specific focus on either powered or unpowered (manually operated) tailgates. Powered tailgates, equipped with motors or hydraulic systems, allow for automatic opening and closing with minimal physical effort. These systems generally require specialized hinge assemblies that can accommodate the additional stresses and operational demands of motorized movement. Conversely, unpowered tailgates rely on manual operation and are typically paired with hinge assemblies that are simpler in design, but require physical force for operation.

One challenge has been the development of a versatile hinge assembly capable of efficient operation in both powered and unpowered tailgates. Such versatility is desirable for greater manufacturing efficiency, as the same hinge assembly can be used across different tailgate designs, e.g. powered and unpowered.

### SUMMARY

This section provides a general summary of the disclosure, and is not a comprehensive disclosure of its full scope or all of its features.

According to a first aspect of the present disclosure, there is provided a hinge assembly configured to couple either a motorized tailgate or a non-motorized tailgate to a side wall of a bed of a vehicle, the hinge assembly including a hinge bracket configured to be fixed to the side wall, an elongated hinge key having a proximate end attached to the hinge bracket and a distal end including a keyed surface, wherein the elongated hinge key is configured to be fixed to a first cup that is configured to be attached to the motorized tailgate and configured to be received within a second cup that is configured to be attached to the non-motorized tailgate such that the second cup can rotate about the elongated hinge key.

According to the first aspect, the distal end includes a threaded aperture configured for receipt of a threaded pin that fixes the hinge key to the first cup and prevents the first cup from rotating relative to the hinge key.

According to the first aspect, the first cup has a through-hole configured to be aligned with the threaded aperture and configured for receipt of the threaded pin.

According to the first aspect, the keyed surface includes a profile that is configured to mate with an interior surface of the first cup that has a profile that corresponds to the profile of the keyed surface to prevent the first cup from rotating relative to the hinge key.

According to the first aspect, the first cup is fixed to the hinge key such that when the motorized tailgate is moved from a closed position to an open position, the motorized tailgate moves relative to the first cup.

According to the first aspect, second cup includes a smooth interior surface that terminates at a bumper that extends radially inward from the interior surface and is configured to be abutted by the keyed surface of the hinge key, the second cup being configured to rotate relative to the hinge key until keyed surface of the hinge key abuts the bumper.

According to the first aspect, the second cup is fixed to the non-motorized tailgate and is configured to rotate about the hinge key as the non-motorized tailgate is moved from a closed position to an open position.

According to a second aspect of the present disclosure, a vehicle including a vehicle body having a bed defined by a pair of side walls, either a motorized tailgate or a non-motorized tailgate positioned between the pair of sidewalls and pivotably coupled to at least one sidewall of the pair of sidewalls by a hinge assembly, the hinge assembly including a hinge bracket configured to be fixed to the one side wall, and an elongated hinge key having a proximate end attached to the hinge bracket and a distal end including a keyed surface, wherein the elongated hinge key is configured to be fixed to a first cup that is configured to be attached to the motorized tailgate and configured to be received within a second cup that is configured to be attached to the non-motorized tailgate such that the second cup can rotate about the elongated hinge key.

According to the second aspect, the distal end includes a threaded aperture configured for receipt of a threaded pin that fixes the hinge key to the first cup and prevents the first cup from rotating relative to the hinge key.

According to the second aspect, the first cup has a through-hole configured to be aligned with the threaded aperture and configured for receipt of the threaded pin.

According to the second aspect, the keyed surface includes a profile that is configured to mate with an interior surface of the first cup that has a profile that corresponds to the profile of the keyed surface to prevent the first cup from rotating relative to the hinge key.

According to the second aspect, the first cup is fixed to the hinge key such that when the motorized tailgate is moved from a closed position to an open position, the motorized tailgate moves relative to the first cup.

According to the second aspect, the second cup includes a smooth interior surface that terminates at a bumper that extends radially inward from the interior surface and is configured to be abutted by the keyed surface of the hinge key, the second cup being configured to rotate relative to the hinge key until keyed surface of the hinge key abuts the bumper.

According to the second aspect, the second cup is fixed to the non-motorized tailgate and is configured to rotate about the hinge key as the non-motorized tailgate is moved from a closed position to an open position.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a vehicle according to a principle of the present disclosure;

FIG. 2 is a partial perspective view of a tailgate and an example tailgate hinge assembly of the vehicle illustrated in FIG. 1;

FIG. 3A is an exploded view of the motorized configuration of the example tailgate hinge assembly according to a principle of the present disclosure.

FIG. 3B is an exploded view of the non-motorized configuration of the example tailgate hinge assembly according to a principle of the present disclosure.

FIG. 4A is a perspective view of the motorized configuration of the example tailgate hinge assembly in the tailgate closed position;

FIG. 4B is a perspective view of the motorized configuration of the example tailgate hinge assembly in the tailgate open position;

FIG. 5A is a perspective view of the non-motorized configuration of the example tailgate hinge assembly in the tailgate closed position;

FIG. 5B is a perspective view of the non-motorized configuration of the example tailgate hinge assembly in the tailgate open position; and

FIG. 6 is a cross section view of the example tailgate hinge assembly.

Corresponding reference numerals indicate corresponding parts throughout the several views of the drawings.

### DETAILED DESCRIPTION

Example embodiments will now be described more fully with reference to the accompanying drawings. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer, or section discussed below could be termed a second element, component, region, layer, or section departing from the teachings of the example embodiments.

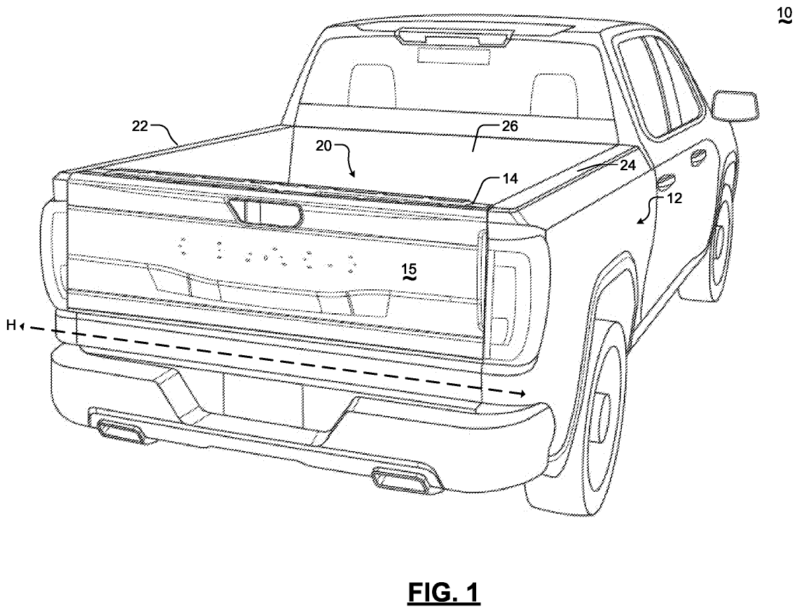

FIG. 1 illustrates an example vehicle 10 according to the present disclosure. The vehicle 10 may be a pickup truck including a body 12 and a tailgate 14. Tailgate 14 may be hollow and formed of an exterior panel 15, a pair of side panels 16, an interior panel 17 that faces a cargo bed 20 of vehicle 10, and a bottom panel 18. Cargo bed 20 may include a bed floor (not shown), a pair of side walls 22 and 24, and a front wall panel 26. The tailgate 14 may be pivotably coupled to the side walls 22 and 24 so that the tailgate 14 is allowed to pivot about a horizontal axis H between a horizonal open position (not shown) and a horizontal closed position (FIG. 1), as is known in the art.

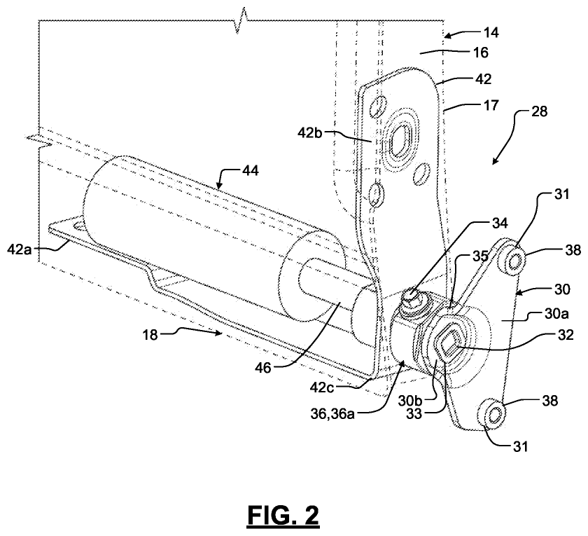

FIG. 2 illustrates a portion of the tailgate 14 having an example tailgate hinge assembly 28 according to the present disclosure. The tailgate hinge assembly 28 may generally include a hinge bracket 30, a hinge key 32, and a cup 36. The tailgate hinge assembly 28 illustrated in FIG. 2 is configured to be positioned between the tailgate 14 and the right side wall 24. It should be understood, however, that the tailgate hinge assembly 28 may be positioned between the left side wall 22 and the tailgate 14 without departing from the scope of the present disclosure.

Tailgate 14 may further include an L-shaped bracket 42 located within the hollow interior 43 of tailgate 14 that includes a bottom leg 42a that extends along bottom panel 18 and a side leg 42b that extends alongside panel 16. Bottom leg 42a and side leg 42b are connected at a joint 42c such that a right angle is formed between bottom leg 42a and side leg 42b. Side leg 42b is configured to be attached to the side panel 16 and the bottom leg 42a is configured to be attached to the bottom panel 18. In a motorized configuration, the L-shaped bracket 42 may be configured to support a tailgate motor 44 at the bottom leg 42a, which is attached to side leg 42b by a rotatable shaft 46 that can rotate L-shaped bracket 42 and tailgate 14 relative to cup 36 and sidewall 22.

The hinge bracket 30 may be attached to the side wall 24 by, for example, fasteners 38. The hinge bracket 30 may be a stamped member that includes a first planar region 30a having a pair of apertures 31 configured for receipt of the fasteners 38 and a second planar region 30b that defines a hinge key aperture 33 configured for receipt of hinge key 32. Second planar region 30b is recessed relative to first planar region 30a and connected to first planar region 30a by a sidewall 35 that extends in a direction towards the tailgate 14. The hinge bracket 30 may be formed of a rigid material such as a metal (e.g., steel or aluminum).

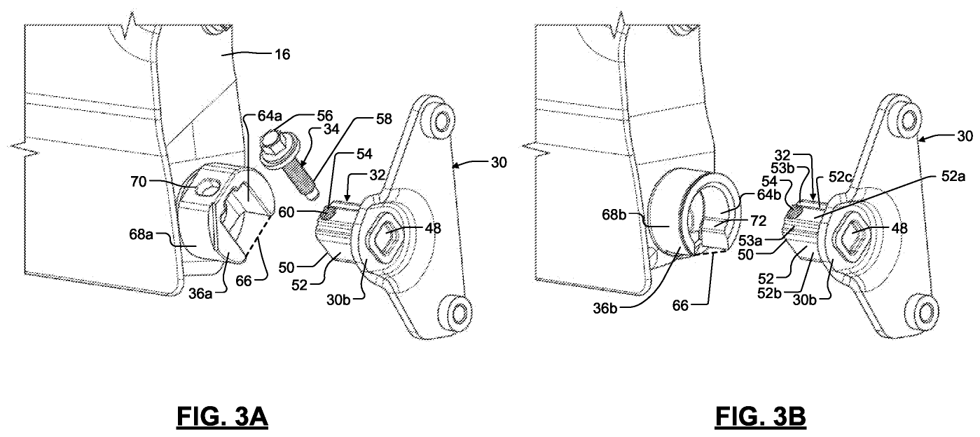

As best shown in FIGS. 3A and 3B, the hinge key 32 is an elongated member having a proximate end 48 attached to hinge key aperture 33, a distal end 50, and a keyed surface 52 that extends between proximate end 48 and distal end 50. The distal end 50 may include a threaded aperture 54 for receiving a pin 34 characterized by a head 56 and a threaded shank 58.

The hinge key 32 may be a generally parallelpiped-shaped member that defines the keyed surface 52, and is configured to to mate with the interior wall 64a or 64b of either of the cup 36a that is configured for use with a motorized tailgate 14 or the cup 36b that is configured for use with a non-motorized tailgate. Put another way, the combination of the hinge bracket 30 and the hinge key 32 is a common feature between the non-motorized tailgate 14 and the motorized tailgate 14 that includes the motor 44. Hinge key 32 includes a first planar side surface 52a that includes threaded aperture 54, a second planar side surface 52b connected to first planar side surface 52a by a first elongated stepped surface 53a, a third planar side surface 52c connected to first planar side surface 52a by a second elongated stepped surface 53b, and an arcuate side surface 52d that connects second planar side surface 52b to third planar side surface 52c.

The cup 36a that is attached to the motorized tailgate 14 is best shown in FIG. 3A and the cup 36b that is attached to the non-motorized tailgate 14 is best shown in FIG. 3B. In either configuration, the cups 36a and 36b may include a gap 66 that permits the tailgate 14 to be detached from hinge key 32. That is, gap 66 may be formed such that when tailgate 14 is pivoted about horizontal axis H from the closed position to an angle of about 45 degrees, tailgate 14 may be pulled away from hinge key 32 and hinge key 32 can exit the gap 66.

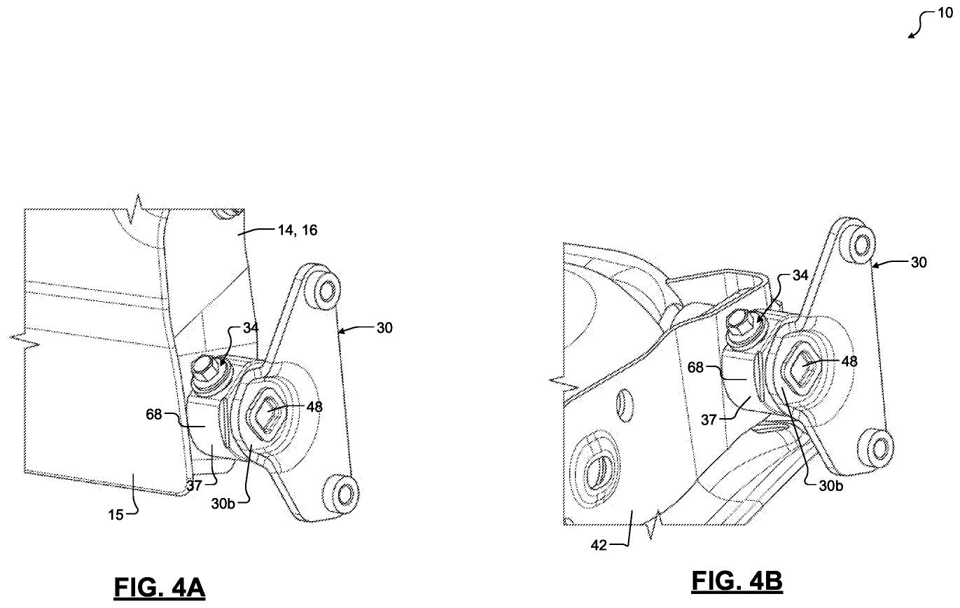

The cup 36a that is attached to the motorized tailgate 14 illustrated in FIG. 3A is fixed relative to the side panel 16 and the L-shaped bracket 42 located within the interior 43 of the tailgate 14 because cup 36a is fixed to hinge key 32 by pin 34 that passes through a through-hole 70 formed in a wall 68 of cup 36a before engaging with threaded aperture 54 of hinge key 32. Cup 36a may include wall 68a having an interior surface 64a that is correspondingly shaped to mate with the keyed surface 52 of hinge key 32 and further prevent rotation of cup 36a relative to hinge key 32. Thus, when tailgate 14 is to be moved from the closed position (FIG. 4A) to the open position (FIG. 4B) by pivoting the tailgate 14 along the horizontal axis H, motor 44 that is connected to L-shaped bracket 42 by shaft 46 will rotate shaft 46, L-shaped bracket 42, and tailgate 14 relative to the fixed cup 36a. It should be noted that tailgate 14 is omitted in FIG. 4B to show the movement of L-shaped bracket 42 relative to cup 36a.

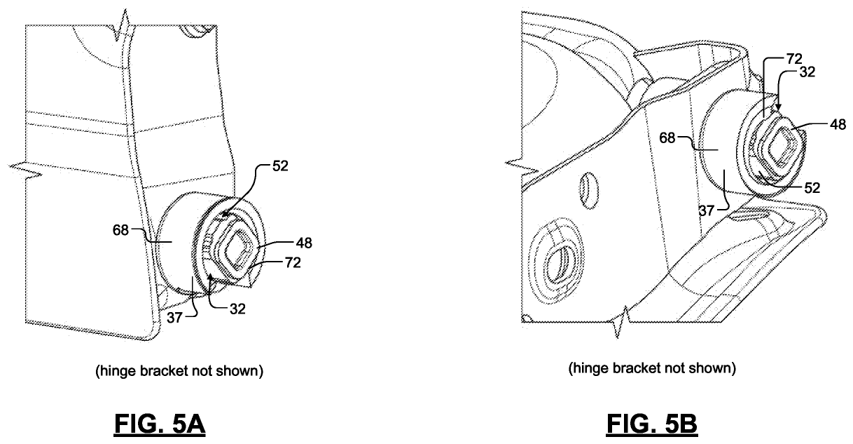

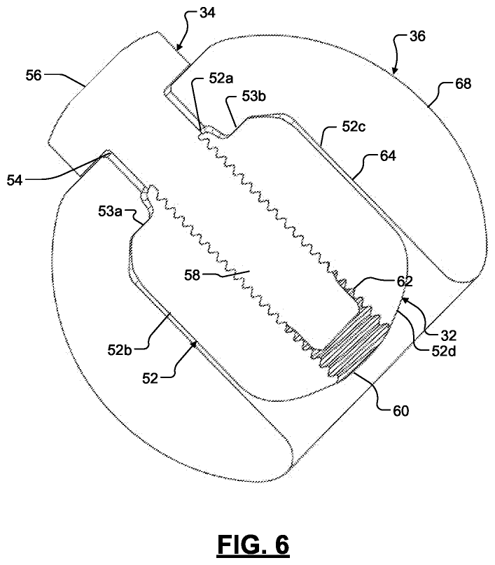

In contrast to the cup 36a used in conjunction with the motorized tailgate 14 that is fixed to the fixed hinge key 32, the cup 36b is configured to be movable relative to the fixed hinge key 32 and, therefore, is fixed to the side panel 16 of the tailgate 14. Inasmuch as cup 36b is movable relative to hinge key 32, cup 36b does not include the through-hole 70 in the cup wall 68b and does not include an interior surface 64b that is shaped to correspond to the keyed surface 52 of hinge key 32. In this regard, interior wall 64b of the cup 36b may include a predominantly smooth and uniform surface that terminates at a bumper 72, which is an angled surface that extends radially inward from interior wall 64b. As best shown in FIGS. 5A and 5B, the uniform surface of the interior wall 64 of the cup 36b allows rotation of cup 36b around the keyed surface 52 of the hinge key 32 as the tailgate 14 is pivoted to the open position about horizontal axis H until bumper 72 is contacted by, for example, second elongated stepped surface 53b that stops rotation of cup 36b relative to hinge key 32.

In summary, the present disclosure provides a combination of a hinge key 32 and a hinge bracket 30 that can be used with either a motorized tailgate 14 or a non-motorized tailgate 14. Inasmuch as the combination of the hinge key 32 and hinge bracket 30 can be used in either design, manufacturing efficiency can be improved and the overall design of a motorized tailgate does not need to be substantially different from the design of a non-motorized tailgate.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A hinge assembly configured to couple either a motorized tailgate or a non-motorized tailgate to a side wall of a bed of a vehicle, the hinge assembly comprising:
a hinge bracket configured to be fixed to the side wall; and
an elongated hinge key having a proximate end attached to the hinge bracket and a distal end including a keyed surface,
wherein the elongated hinge key is configured to be fixed to a first cup that is configured to be attached to the motorized tailgate and configured to be received within a second cup that is configured to be attached to the non-motorized tailgate such that the second cup can rotate about the elongated hinge key.

2. The hinge assembly of claim 1, wherein the distal end includes a threaded aperture configured for receipt of a threaded pin that fixes the hinge key to the first cup and prevents the first cup from rotating relative to the hinge key.

3. The hinge assembly of claim 2, wherein the first cup has a through-hole configured to be aligned with the threaded aperture and configured for receipt of the threaded pin.

4. The hinge assembly of claim 1, wherein the keyed surface includes a profile that is configured to mate with an interior surface of the first cup that has a profile that corresponds to the profile of the keyed surface to prevent the first cup from rotating relative to the hinge key.

5. The hinge assembly of claim 4, wherein the first cup is fixed to the hinge key such that when the motorized tailgate is moved from a closed position to an open position, the motorized tailgate moves relative to the first cup.

6. The hinge assembly of claim 1, wherein second cup includes a smooth interior surface that terminates at a bumper that extends radially inward from the interior surface and is configured to be abutted by the keyed surface of the hinge key, the second cup being configured to rotate relative to the hinge key until keyed surface of the hinge key abuts the bumper.

7. The hinge assembly of claim 6, wherein the second cup is fixed to the non-motorized tailgate and is configured to rotate about the hinge key as the non-motorized tailgate is moved from a closed position to an open position.

8. A vehicle comprising:
a vehicle body having a bed defined by a pair of side walls;
either a motorized tailgate or a non-motorized tailgate positioned between the pair of sidewalls and pivotably coupled to at least one sidewall of the pair of sidewalls by a hinge assembly, the hinge assembly including:
a hinge bracket configured to be fixed to the one side wall; and
an elongated hinge key having a proximate end attached to the hinge bracket and a distal end including a keyed surface,
wherein the elongated hinge key is configured to be fixed to a first cup that is configured to be attached to the motorized tailgate and configured to be received within a second cup that is configured to be attached to the non-motorized tailgate such that the second cup can rotate about the elongated hinge key.

9. The vehicle of claim 8, wherein the distal end includes a threaded aperture configured for receipt of a threaded pin that fixes the hinge key to the first cup and prevents the first cup from rotating relative to the hinge key.

10. The vehicle of claim 9, wherein the first cup has a through-hole configured to be aligned with the threaded aperture and configured for receipt of the threaded pin.

11. The vehicle of claim 8, wherein the keyed surface includes a profile that is configured to mate with an interior surface of the first cup that has a profile that corresponds to the profile of the keyed surface to prevent the first cup from rotating relative to the hinge key.

12. The vehicle of claim 11, wherein the first cup is fixed to the hinge key such that when the motorized tailgate is moved from a closed position to an open position, the motorized tailgate moves relative to the first cup.

13. The vehicle of claim 8, wherein second cup includes a smooth interior surface that terminates at a bumper that extends radially inward from the interior surface and is configured to be abutted by the keyed surface of the hinge key, the second cup being configured to rotate relative to the hinge key until keyed surface of the hinge key abuts the bumper.

14. The vehicle of claim 13, wherein the second cup is fixed to the non-motorized tailgate and is configured to rotate about the hinge key as the non-motorized tailgate is moved from a closed position to an open position.
